(19) United States
(12) Patent Application Publication
(10) Pub. No.: US 2025/0161980 A1
(43) Pub. Date: May 22, 2025

(54) METAL MEMBER, METAL-RESIN COMPOSITE BODY, AND METHOD FOR PRODUCING METAL MEMBER

(71) Applicant: MITSUI CHEMICALS, INC., Chuo-ku, Tokyo (JP)

(72) Inventors: Yuta KODERA, Ichihara-shi, Chiba (JP); Shintaro MITSUNAGA, Kinshicho, Sumida-ku, Tokyo (JP); Norio HIRAMITSU, Ichihara-shi, Chiba (JP)

(73) Assignee: MITSUI CHEMICALS, INC., Chuo-ku, Tokyo (JP)

(21) Appl. No.: 18/839,083

(22) PCT Filed: Jan. 30, 2023
(86) PCT No.: PCT/JP2023/002914

§ 371 Date: Aug. 16, 2024

(30) Foreign Application Priority Data
Feb. 21, 2022 (JP) 2022-025116

(51) Int. Cl. B05D 5/02

(52) U.S. Cl. CPC B05D 5/02

(57) ABSTRACT

A metal member, including a surface having irregularities, and satisfying at least one of the following (1) to (3): (1) the surface is covered with a hydrophobic film; (2) the surface has a contact angle with respect to water of 90° or more; or (3) the surface has an organic compound that is chemically bonded to the surface.

### TECHNICAL FIELD

The present disclosure relates to a metal member, a metal-resin composite body, and a method for producing a metal member.

### BACKGROUND ART

As a method for roughening a surface of a metal member, a method including forming micrometer-order irregularities at a surface of a metal member, and subsequently forming nanometer-order irregularities on the micrometer-order irregularities, has been proposed (see Patent Document 1, for example).

### PRIOR ART DOCUMENT

### Patent Document

Patent Document 1: International Publication No. 2020/158820

### SUMMARY OF THE INVENTION

### Problem to be Solved by the Invention

The metal member having a surface roughened by the method described in Patent Document 1 exhibits excellent joint strength with respect to a resin member, for example, by having nanometer-order irregularities on the surface. However, the metal member having a surface roughened by the method described in Patent Document 1 has the problem that the nanometer-order irregularities formed on the surface disappear over time. The reason for the disappearance of nanometer-order irregularities is thought to be that a metal hydroxide, which is generated by a reaction of the surface of the metal member with moisture in the air, fills the nanometer-order irregularities.

In view of the foregoing, an embodiment of the present disclosure aims to provide a metal member having a surface on which irregularities are retained for a long period of time; a metal-resin complex body using the metal member; and a method of producing the metal member.

### Means for Solving the Problem

The means for solving the problem includes the following embodiments.

<1> A metal member, including a surface having irregularities, the surface being covered with a hydrophobic film.

<2> A metal member, including a surface having irregularities, the surface having a contact angle with respect to water of 90° or more.

<3> A metal member, including a surface having irregularities, the surface having an organic compound that is chemically bonded to the surface.

<4> The metal member according to <3>, wherein the organic compound has a polar group.

<5> The metal member according to any one of <1> to <4>, wherein the irregularities include a dendritic morphology.

<6> The metal member according to <5>, wherein the dendritic morphology has an average thickness of from 20 nm to 1000 nm.

<7> The metal member according to any one of <1> to <4>, wherein the surface has an average value of ten-point average roughness (Rzjis) of from 2 μm to 50 μm.

<8> The metal member according to any one of <1> to <4>, wherein the surface has an average value of average length of roughness curve element (RSm) of from 10 μm to 400 μm.

<9> The metal member according to any one of <1> to <4>, including aluminum.

<10> A metal-resin composite body, including the metal member according to any one of <1> to <4>, and a resin member that is joined to the surface having the irregularities of the metal member.

<11> A method for producing a metal member, the method including:
forming irregularities at a surface of a metal member; and
applying an organic compound to the surface at which the irregularities have been formed.

<12> The method for producing a metal member according to <11>, wherein the organic compound has an alkyl group with a carbon number of from 1 to 20.

<13> The method for producing a metal member according to <11>, wherein the organic compound has a polar group.

### Effect of the Invention

According to an embodiment of the present disclosure, it is possible to provide a metal member having a surface on which irregularities are retained for a long period of time; a metal-resin complex body using the metal member; and a method of producing the metal member.

### BRIEF DESCRIPTION OF THE DRAWINGS

FIG. 1 is electron microscope images showing the result of high-temperature high-humidity storage test conducted in Example 1.

FIG. 2 is electron microscope images showing the result of high-temperature high-humidity storage test conducted in Example 2.

FIG. 3 is electron microscope images showing the result of high-temperature high-humidity storage test conducted in Example 3.

FIG. 4 is electron microscope images showing the result of high-temperature high-humidity storage test conducted in Example 4.

In the present disclosure, any numerical range described using the expression “from*to” represents a range in which numerical values described before and after the “to” are included in the range as a minimum value and a maximum value, respectively.

In a numerical range described in stages, in the present disclosure, an upper limit value or a lower limit value described in one numerical range may be replaced with an upper limit value or a lower limit value in another numerical range described in stages. Further, in a numerical range described in the present disclosure, the upper limit value or the lower limit value in the numerical range may be replaced with a value shown in the Examples.

In the present disclosure, when a component of a composition includes plural kinds of substances, the content of the component refers to the total content of the plural kinds of substances present in the composition, unless otherwise specified.

### Metal Member (First Embodiment)

A first embodiment of the metal member of the present disclosure is a metal member, including a surface having irregularities, the surface being covered with a hydrophobic film.

The metal member of the present embodiment retains favorable irregularities formed at a surface thereof even after a long period of time from the roughening treatment to the surface. The reason for this is thought to be that the hydrophobic film that covers the surface of the metal member suppresses the contact of the surface of the metal member with moisture in the air, and generation of a metal hydroxide at the surface of the metal member is suppressed.

There are no particular restrictions on the component included in the hydrophobic film, the method of forming the hydrophobic film, or the like. The hydrophobic film preferably has a contact angle with respect to water of 90° or more, more preferably 100° or more, further preferably 110° or more.

In the present disclosure, the contact angle with respect to water is measured by the method described in the Examples described below.

From the viewpoint of the strength of the hydrophobic film, the hydrophobic film is preferably formed from an organic compound.

From the viewpoint of forming a film while reducing the effect on the irregularities at the surface of the metal member, the molecular weight of the organic compound is preferably 1,000 or less, more preferably 500 or less, further preferably 300 or less.

The organic compound preferably has a hydrophobic functional group such as a hydrocarbon group.

The hydrocarbon group of the organic compound may be linear or cyclic. Examples of the linear hydrocarbon group include an alkyl group. The alkyl group may include a double bond or a triple bond, or may not include a double bond or a triple bond. Examples of the cyclic hydrocarbon group include an aryl group and a cycloalkyl group.

From the viewpoint of durability of the film formed from the organic compound, the organic compound is preferably chemically bonded to the surface of the metal member. In other words, the surface of the metal member is preferably covered with an organic compound that is capable of chemically bonding to the surface of the metal member.

The type of the organic compound that chemically bonds to the surface of the metal member is not particularly limited, and may be selected depending on the material of the surface of the metal member or the like. For example, when a hydroxy group exists at the surface of the metal member, an organic compound having a functional group that reacts with a hydroxy group may be selected. Examples of the foregoing organic compound include a compound having an alkyl group with a carbon number of from 1 to 20 and a functional group that reacts with a hydroxy group.

Specific examples of the organic compound that chemically bonds to the surface of the metal member include a phosphonic acid compound, a silane compound, a carboxylic acid derivative, a fluorohydrocarbon, and a thiol derivative.

Specific examples of the compound that chemically bonds to the surface of the metal member and has an alkyl group with a carbon number of from 1 to 20 include a phosphonic acid compound having an alkyl group with a carbon number of from 1 to 20, a silane compound having an alkyl group with a carbon number of from 1 to 20, a carboxylic acid derivative, a fluorohydrocarbon, and a thiol derivative.

The organic compound may be a compound having an alkyl group with a carbon number of from 1 to 20.

In the compound having an alkyl group with a carbon number of from 1 to 20, the carbon number of the alkyl group is not particularly limited as long as it is within a range of from 1 to 20. The carbon number of the alkyl group may be 3 or more, 5 or more, 10 or more, or 15 or more. The carbon number of the alkyl group may be 18 or less, 15 or less, or 12 or less.

The carbon number of the alkyl group may be selected depending on the type of a resin member to be joined to the surface of the metal member.

For example, when the resin member to be joined to the surface of the metal member includes a polar group (for example, an amide group in polyamide), the carbon number of the alkyl group may be 12 or less, 10 or less, or 5 or less. By reducing the carbon number of the alkyl group, a distance between the surface of the metal member and the resin member can be shortened. As a result, an interaction between the surface of the metal member and the resin member may express effectively, and favorable bonding strength may be achieved in some cases, while suppressing the contact of the surface of the metal member with moisture in the air.

The alkyl group with a carbon number of from 1 to 20 may be unsubstituted or may have a substituent, preferably unsubstituted.

The alkyl group with a carbon number of from 1 to 20 may have a linear structure or a branched structure, preferably a linear structure.

The number of the alkyl group with a carbon number of from 1 to 20 in the compound may be one or two or more, preferably one.

The organic compound preferably forms a self-assembled monolayer at the surface of the metal member.

The self-assembled monolayer has an extremely small thickness of approximately from 1 to 2 nanometers. Therefore, the hydrophobic film formed at the surface of the metal member exhibits less effect on the nanometer-order irregularities.

Specific examples of the organic compound that can form a self-assembled monolayer on the roughened surface of the antibacterial member include a phosphonic acid compound having a hydrocarbon group and a silane compound having a hydrocarbon group. The hydrocarbon group is preferably a linear hydrocarbon group, more preferably an alkyl group.

Specific examples of the compound having an alkyl group with a carbon number of from 1 to 20 that can form a self-assembled monolayer on the surface of the metal member include a phosphonic acid compound having an alkyl group with a carbon number of from 1 to 20 and a silane compound having an alkyl group with a carbon number of from 1 to 20. From the viewpoint of stability of the self-assembled monolayer, a phosphonic acid compound having an alkyl group with a carbon number of from 1 to 20 is preferred.

A phosphonic acid compound forms a self-assembled monolayer that is higher in density than a silane compound. The reason for this is thought to be that while a silane compound reacts only with a hydroxy group (OH) at the surface of the metal member, a phosphonic acid compound regenerates the OH by supplying a proton (H⁺) to the surface of the metal member, thereby causing a chain reaction. Accordingly, a self-assembled monolayer formed with a phosphonic acid compound is thought to exhibit excellent stability.

The organic compound may have a polar group.

When the organic compound has a polar group, for example, favorable joining strength may be achieved when a resin member including a polar group is joined to the metal member, in some cases.

The polar group that the organic compound may have refers to a polar group other than a functional group that causes the compound to chemically bond to the surface of the metal member.

Specific examples of the polar group include an amino group, a carboxy group, a hydroxy group, a sulfo group, a sulfonimide group, a sulfate group, a phosphonate group, a phosphate group, an amino group, an ammonium group, an epoxy group, and a thiol group.

When the organic compound has a polar group, the position of the polar group is not particularly limited. For example, when the organic compound has a hydrocarbon group, the polar group may be bound to the hydrocarbon group, or may be bound to a terminal of the hydrocarbon group.

When the organic compound has a polar group and a functional group that causes the organic compound to chemically bond to the surface of the metal member, the positions of the polar group and the functional group are not particularly limited. For example, when the organic compound has a hydrocarbon group, the polar group and the functional group may be bound to the hydrocarbon group at different positions from each other, or may be bound to each of the terminals of the hydrocarbon group, respectively.

When the organic compound has a polar group, the number of the polar group is not particularly limited. For example, the number of the polar group may be from 1 to 3, 1 or 2, or 1. When the organic compound has two or more polar group, the two or more polar groups may be the same kind or different kinds from each other.

The method for applying the organic compound to the surface of the metal member is not particularly limited. Specific examples of the method include a method in which a liquid in which the organic compound is dissolved or dispersed is applied to the surface or the metal member; and a method in which the metal member is dipped in the foregoing liquid.

A thermal treatment may be conducted after applying the organic compound to the surface of the metal member. By conducting the thermal treatment, for example, the chemical bonding of the organic compound to the surface of the metal member can be promoted.

The material for the metal member is not particularly limited. Specific examples of the metal member include iron, copper, nickel, gold, silver, platinum, cobalt, zinc, lead, tin, titanium, chromium, aluminum, magnesium and manganese, and alloys including at least one selected from the foregoing metals.

The metal member of the present embodiment has a surface that is covered with a hydrophobic film. Therefore, favorable irregularities are retained over a long period of time even in a case of a material in which a metal hydroxide is generated at the surface by a reaction with moisture in the air, such as aluminum.

The metal member may be composed of a single kind of material or two or more kinds of materials.

The metal member may be composed of a main body and a plating layer that is formed at a surface of the main body.

The irregularities formed at the surface of the metal member may include a dendritic morphology.

In the present disclosure, the “dendritic morphology” refers to a structure in which stems having multiple branches bristle at the surface of the metal member. The dendritic morphology may be composed of a stem that stands at the surface of the metal member (main stem), a branch that diverges from the main stem (main branch), and a branch that diverges from the main branch (side branch), and the like, for example.

Whether or not a dendritic morphology is formed at the surface of the metal member can be determined by, for example, observing a section profile of the metal member with a scanning electron microscope (SEM).

The average number density of the main stems in the dendritic morphology is preferably 5 stems/μm or more, more preferably 7 stems/μm or more, further preferably 10 stems/μm or more.

The average number density of the main stems in the dendritic morphology is preferably 40 stems/μm or less, more preferably 35 stems/μm or less, further preferably 30 stems/μm or less.

The average number density of the main stems in the dendritic morphology is calculated based on a section profile of the metal member obtained with a scanning electron microscope (SEM). Specifically, the average number density of the main stems is obtained as an arithmetic average value of the values measured at arbitrary 10 points.

The average thickness of the dendritic morphology is preferably from 20 nm to 1000 nm, more preferably from 30 nm to 900 nm, further preferably from 50 nm to 800 nm.

The average thickness of the dendritic morphology is calculated based on a section profile of the metal member obtained with a scanning electron microscope (SEM). Specifically, the average thickness is obtained as an arithmetic average value of the values measured at arbitrary 10 points.

The surface of the metal member preferably satisfies at least one of the following (1) or (2). When the surface of the metal member satisfies at least one of (1) or (2), it is deemed that micrometer-order irregularities are formed at the surface of the metal member.

(1) an average value of ten-point average roughness (Rzjis) is from 2 μm to 50 μm.

(2) an average value of average length of roughness curve element (RSm) is from 10 μm to 400 μm.

In the present disclosure, the ten-point average roughness (Rzjis) is measured based on JIS B 0601:2001 (corresponding international standard: ISO 4287).

In the present disclosure, the average value of average length of roughness curve element (RSm) is measured based on JIS B 0601:2001 (corresponding international standard: ISO 4287).

The average value of the ten-point average roughness (Rzjis) at the surface of the metal member is preferably from 5 μm to 30 μm, more preferably from 8 μm to 25 μm, further preferably from 10 μm to 20 μm.

The average value of the ten-point average roughness (Rzjis) at the surface of the metal member is obtained as an arithmetic average value of the values measured at arbitrary 10 points at the surface having irregularities of the metal member.

The average value of the average value of average length of roughness curve element (RSm) is preferably from 50 μm to 350 μm, more preferably from 70 μm to 330 μm, further preferably from 70 μm to 250 μm, yet further preferably from 70 μm to 230 μm.

The average value of the average value of average length of roughness curve element (RSm) at the surface of the metal member is obtained as an arithmetic average value of the values measured at arbitrary 10 points at the surface having irregularities of the metal member.

The surface of the metal member preferably satisfies at least one of the foregoing (1) or (2) and includes a dendritic morphology.

Having a surface that satisfies at least one of the foregoing (1) or (2) and includes a dendritic morphology indicates that micrometer-order irregularities (base roughened surface) are formed at the surface of the metal member, and nanometer-order irregularities (fine roughened surface) are further formed on the surface of the micrometer-order irregularities (double roughened surface).

When the surface of the metal member is in a state of a double roughened surface, for example, the metal member exhibits excellent joining strength with respect to a resin member.

The average pore diameter of the concave portions in the irregularities at the surface of the metal member may be from 5 nm to 250 μm, for example, preferably from 10 nm to 150 μm, more preferably from 15 nm to 100 μm.

The average pore depth of the concave portions in the irregularities at the surface of the metal member may be from 5 nm to 250 μm, for example, preferably from 10 nm to 150 μm, more preferably from 15 nm to 100 μm.

When the average pore diameter and/or the average pore depth of the concave portions in the irregularities at the surface of the metal member are within the foregoing ranges, a further strong joining strength tends to be achieved.

The average pore diameter and the average pore depth of the concave portions in the irregularities may be obtained by using an electron microscope or a laser microscope. Specifically, images of the surface and a section of the surface of the metal member are obtained, and arbitral 50 concave portions are selected from the images. The average pore diameter and the average pore depth are obtained as arithmetic average values of the pore diameter and the pore depth measured at the 50 concave portions, respectively.

The method for performing the surface treatment to the metal member is not particularly limited, and may be selected from the known methods.

Examples of the method include a method using laser light as described in Japanese Patent No. 4020957; a method of immersing a surface of the metal member in an aqueous solution of an inorganic base such as NaOH or an inorganic acid such as HCl or HNO₃; a method of subjecting a surface of the metal member to anodization as described in Japanese Patent No. 4541153; a substitution crystallization method in which a surface of the metal member is etched with an aqueous solution including an acid-based etchant (preferably an inorganic acid, ferric ion or cupric ion) and optionally including manganese ions, aluminum chloride hexahydrate, sodium chloride or the like, as described in International Publication No. 2015/8847; a method of immersing a surface of the metal member in an aqueous solution of at least one selected from hydrazine hydrate, ammonia or a water-soluble amine compound (hereinafter, also referred to as an NMT method), as described in International Publication No. 2009/31632; a method of treating a surface of the metal member with a warm water, as described in JP-A No. 2008-162115; and a blast treatment.

The roughening treatment to the metal member may be a method described in Japanese Patent No. 5366076 in which a porous plating layer is formed at a surface of the metal member.

Among these methods, from the viewpoint of securing the joining strength of the metal member with respect to the resin member, a treatment with an acid-based etchant is preferred.

Specific examples of the treatment with an acid-based etchant include a method in which the following processes (1) to (4) are performed in this order.

### (1) Pre-Treatment

In order to remove a film formed of an oxide, a hydroxide or the like from a surface of the metal member, the metal member is subjected to pre-treatment. The pre-treatment is generally performed by mechanical polishing or chemical polishing. When the metal member is significantly contaminated with machine oil or the like at a surface to be joined to the resin component, it is possible to perform a treatment with an alkali aqueous solution containing sodium hydroxide, potassium hydroxide or the like, or a treatment for defatting.

(2) Treatment with Zinc Ion-Containing Alkali Aqueous Solution

The metal member after being subjected to the pre-treatment is immersed in a zinc ion-containing alkali aqueous solution to form a zinc-containing film at a surface thereof. The Zn ion-containing alkali aqueous solution contains an alkali hydroxide (MOH or M(OH)₂) and zinc ions (Zn²⁺) at a mass ratio (MOH or M(OH)₂/Zn²⁺) of from 1 to 100. The M in MOH refers to an alkali metal or an alkali earth metal.

(3) Treatment with Acid-Based Etchant

The metal member is treated with an acid-based etchant containing an acid and at least one of ferric ions or cupric ions. In this treatment, the zinc-containing film is dissolved, and micrometer-order irregularities are formed on a surface of the metal member.

### (4) After-Treatment

The metal member is cleansed, generally by performing water-washing and drying. The after-treatment may include ultrasonic washing for desmutting.

The surface treatment may be performed twice or more. For example, the metal member may be subjected to a process for forming a micrometer-order irregularities (base roughened surface) by performing the processes (1) to (4), and subsequently a process for forming nanometer-order irregularities (fine roughened surface).

Examples of the method for forming a fine roughened surface after forming a base roughened surface to the metal member include a method of contacting the metal member with an oxidizable acidic aqueous solution. The oxidizable acidic aqueous solution contains metallic cations having a standard electrode potential E° of greater than-0.2 and 0.8 or less, preferably greater than 0 and 0.5 or less.

The oxidizable acidic aqueous solution preferably does not contain metallic cations having a standard electrode potential E° of −0.2 or less.

Examples of the metallic cations having a standard electrode potential E⁰ of greater than −0.2 and 0.8 or less include Pb²⁺, Sn²⁺, Ag⁺, Hg²⁺ and Cu²⁺. Among these, Cu²⁺ is preferred in view of scarcity of the metal, and in view of safety or toxicity of a metal salt thereof.

Examples of the compound that generates Cu²⁺ include inorganic compounds such as copper hydroxide, copper (II) oxide, copper (II) chloride, copper (II) bromide, copper sulfate and copper nitrate. From the viewpoint of safety, toxicity and efficiency of formation of a dendritic layer, copper oxide is preferred.

The oxidizable acidic aqueous solution includes nitric acid or a mixture of nitric acid with any one of hydrochloric acid, hydrofluoric acid or sulfuric acid. It is also possible to use a percarboxylic acid aqueous solution such as peracetic acid or performic acid.

When nitric acid is used as the oxidizable acidic aqueous solution and copper (II) oxide is used as the compound that generates metallic cations, the concentration of nitric acid in the aqueous solution may be, for example, from 10% by mass to 40% by mass, preferably from 15% by mass to 38% by mass, more preferably from 20% by mass to 35% by mass. The concentration of coper ions in the aqueous solutions may be, for example, from 1% by mass to 15% by mass, preferably from 2% by mass to 12% by mass, more preferably from 2% by mass to 8% by mass.

The temperature at which the metal member having a base roughened surface with an oxidizable acidic aqueous solution is not particularly limited. From the viewpoint of completing the roughening at an economically reasonable pace while suppressing an exothermic reaction, the temperature may be, for example, from ordinary temperature to 60° C., preferably from 30° C. to 50° C. The time for the treatment may be, for example, from 1 minute to 15 minutes, preferably from 2 minutes to 10 minutes.

### <Metal Member (Second Embodiment)>

A second embodiment of the present disclosure is a metal member, including a surface having irregularities, the surface having a contact angle with respect to water of 90° or more.

The metal member of the present embodiment retains favorable irregularities formed at a surface thereof even after a long period of time from the roughening treatment to the surface. The reason for this is thought to be that by setting the contact angle with respect to water at the surface of the metal member to 90° or more, the contact of the surface of the metal member with moisture in the air is suppressed, and generation of a metal hydroxide at the surface of the metal member is suppressed.

From the viewpoint of retaining favorable irregularities at the surface of the metal member, the contact angle with respect to water at the surface of the metal member is preferably 100° or more, more preferably 110° or more.

There are no particular restrictions on the method of setting the contact angle with respect to water at the surface of the metal member to 90° or more. For example, the contact angle with respect to water may be adjusted by causing a compound having a hydrophobic functional group, such as a hydrocarbon group, to chemically bond to the surface of the metal member. The details of the compound having a hydrocarbon group are as mentioned above in connection with the first embodiment of the metal member.

### <Metal Member (Third Embodiment)>

A third embodiment of the present disclosure is a metal member, including a surface having irregularities, the surface having an organic compound that is chemically bonded to the surface.

The metal member of the present embodiment retains favorable irregularities formed at a surface thereof even after a long period of time from the roughening treatment to the surface. The reason for this is thought to be that by having an organic compound that is chemically bonded to the surface of the metal member, the contact of the surface of the metal member with moisture in the air is suppressed, and generation of a metal hydroxide at the surface of the metal member is suppressed.

The details and preferred embodiments of the organic compound are the same as the details and preferred embodiments of the organic compound described above in connection with the first embodiment of the metal member.

The surface at which the organic compound is chemically bonded may be hydrophobic or hydrophilic.

Examples of the case in which the surface at which the organic compound is chemically bonded is hydrophobic include a case in which the organic compound that is chemically bonded to the surface of the metal member has a hydrophobic functional group, such as a hydrocarbon group.

Examples of the case in which the surface at which the organic compound is chemically bonded is hydrophilic include a case in which the organic compound that is chemically bonded to the surface of the metal member has a hydrophilic functional group, such as a polar group.

When the surface at which the organic compound is chemically bonded is hydrophilic, the organic compound preferably includes a hydrophilic functional group (for example, a polar group as mentioned above) and a hydrophobic functional group (for example, a hydrocarbon group as mentioned above). By including a hydrophobic functional group in the organic compound that is chemically bonded to the surface of the metal member, a hydrophobic functional group is disposed at the surface of the metal member. As a result, the contact of the surface of the metal member with an exterior environment is effectively suppressed even if the surface to which the organic compound is chemically bonded is hydrophilic.

### <Metal-Resin Composite Body>

The metal-resin composite body of the present disclosure is a metal-resin composite body, including the metal member of the present disclosure, and a resin member that is joined to the surface having the irregularities of the metal member.

In the present disclosure, the state in which the metal member and the resin member are “joined” refers to a state in which the metal member is fixed to the resin member without using an adhesive, a screw or the like.

The state in which the metal member and the resin member are joined may be formed by, for example, applying a material for the resin member that is in a fluid state by way of melting or softening to the surface having irregularities of the metal member. When the material for the resin member is in a fluid state, the material enters the irregularities at the surface of the metal member and express an anchoring effect, whereby the resin member is tightly joined to the surface of the metal member.

The type of the resin included in the resin member is not particularly limited, and may be thermoplastic resin, thermosetting resin, thermoplastic elastomer, thermosetting elastomer and the like.

Examples of the thermoplastic resin include polyethylene (PE), polypropylene (PP), polystyrene (PS), acrylonitrile/styrene resin (AS), acrylonitrile/butadiene/styrene resin (ABS), polymethacrylate (PMMA), polyvinyl chloride (PVC), polyamide (PA), polyacetal (POM), ultra-high-molecular-weight polyethylene (UHPE), polybutylene terephthalate (PBT), polyethylene terephthalate (PET), polymethylpentene (TPX), polycarbonate (PC), modified polyphenylene ether (PPE), polyphenylene sulfide (PPS), polyetheretherketone (PEEK), liquid crystal polymer (LCP), polytetrafluoroethylene (PTFE), polyetherimide (PEI), polyarylate (PAR), polysulfone (PSF), polyethersulfone (PES) and polyamide imide (PAI).

Examples of the thermosetting resin include phenol resin, urea resin, melamine resin, unsaturated polyester, alkyd resin, epoxy resin and polydiallylphthalate.

Examples of the thermoplastic elastomer include thermoplastic styrenic elastomer, thermoplastic polyester elastomer, thermoplastic polyurethane elastomer and thermoplastic polyamide elastomer.

Examples of the thermosetting elastomer include diene rubbers such as natural rubber (NR), isoprene rubber (IR), butadiene rubber (BR), styrene-butadiene copolymer rubber (SBR), chloroprene rubber (CR) and acrylonitrile-butadiene copolymer rubber (NBR); and non-diene rubbers such as butyl rubber (IIR), ethylene-propylene rubber (EPM), urethane rubber, silicone rubber and acrylic rubber.

The resin included in the resin member may be in a state of ionomer or a polymer alloy.

The resin member may include a single kind of resin or two or more kinds of resins.

The resin member may include various kinds of additives in addition to the resin.

Examples of the additive include fillers such as glass fiber, carbon fiber or inorganic powder, thermal stabilizers, antioxidants, pigments, weathering agents, fire retardants, plasticizers, dispersants, lubricants, releasing agents, and antistatic agents.

When the resin member includes a component other than the resin, the proportion of the resin with respect to the total resin member is preferably 10% by mass or more, more preferably 20% by mass or more, further preferably 30% by mass or more.

The process of joining the resin member with the surface having irregularities of the metal member may be performed by a known method such as injection molding, for example.

### <Method for Producing Metal Member>

The method for producing a metal member of the present disclosure is a method for producing a metal member, the method including:

forming irregularities at a surface of a metal member; and
applying an organic compound to the surface at which the irregularities have been formed.

In the foregoing method, the organic compound may be changed to a hydrophobizing agent. The hydrophobizing agent refers to a substance capable of hydrophobizing a surface at which irregularities are formed.

The metal member produced by the foregoing method retains favorable irregularities even after a long period of time from the formation of the irregularities at the surface thereof. The reason for this is thought to be that the contact of the surface of the metal member with moisture in the air is suppressed by the organic compound applied to the surface having irregularities of the metal member, whereby generation of a metal hydroxide at the surface of the metal member is suppressed.

In the foregoing method, there are no particular restrictions on the method for forming the irregularities at the surface of the metal member. For example, the method may be selected from those illustrated in connection with the foregoing metal member.

In the foregoing method, there are no particular restrictions on the method for applying the organic compound to the surface of the metal member at which the irregularities have been formed. Examples of the method include a method in which a liquid in which the organic compound is dissolved or dispersed is applied to the surface of the metal member, and a method in which the metal member is dipped in the foregoing liquid.

The details and preferred embodiments of the organic compound used in the method are the same as the details and preferred embodiments of the organic compound described in connection with the metal member of the first embodiment.

A thermal treatment may be conducted after applying the organic compound to the surface of the metal member. By conducting the thermal treatment, for example, the chemical bonding of the organic compound to the surface of the metal member can be promoted.

### EXAMPLES

In the following, embodiments according to the present disclosure are described by referring to the Examples. The present disclosure is not restricted in any way by the Examples.

### Example 1

### (1) Surface Treatment of Aluminum Alloy Plate

A plate formed of aluminum alloy (A3003) was subjected to a roughening treatment including forming micrometer-order irregularities with an acid-based etchant, and further forming nanometer-order irregularities on the micrometer-order irregularities (i.e., modifying the surface to be in a state of satisfying the forgoing (1) and (2) and including a dendritic morphology).

The aluminum alloy plate after the roughening treatment was dipped in an ethanol solution of n-octadecyl phosphonic acid (5 mmol/L) for 1 minute. Thereafter, the aluminum alloy plate was washed with ethanol and dried at 80° C. for 20 minutes.

A drop of ion exchange water (2 μL) was put on the surface of the aluminum alloy plate treated with n-octadecyl phosphonic acid, and the contact angle was measured after 1 minute from the dropping. The measurement was performed at a temperature of 24° C. and a relative humidity of 31%. The contact angle calculated by a tangent method from an image of the drop captured with a digital camera was 119°.

### (2) High-Temperature High-Humidity Storage Test

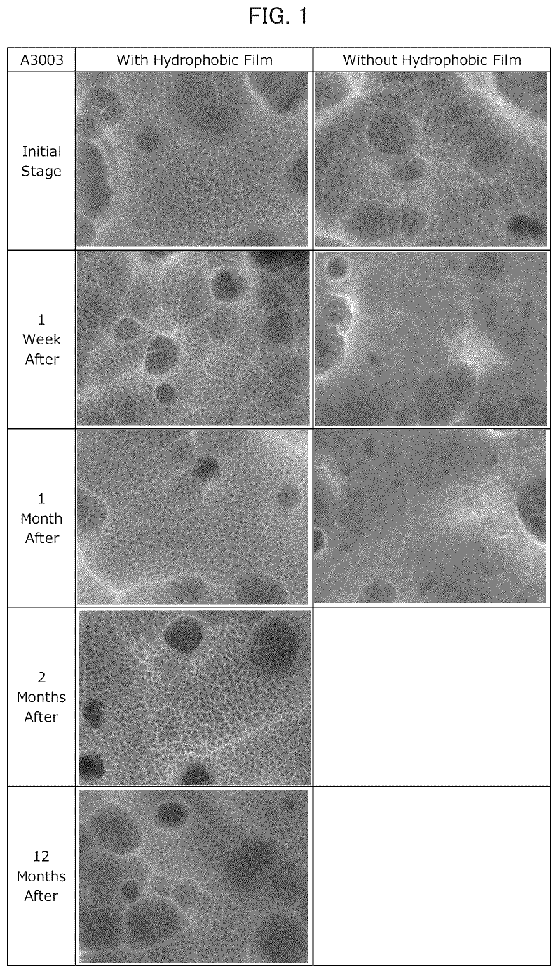

The aluminum alloy plate treated with n-octadecyl phosphonic acid was subjected to a test in which the aluminum alloy plate was stored in an environment at a temperature of 40° C. and a relative humidity of 90%. Electron microscope images of the surface of the aluminum alloy plate were obtained at the start of the test (initial stage) and at 1 week, 1 month or 2 months after the start of the test. The images are shown in FIG. 1.

For the purpose of comparison, an aluminum alloy plate not treated with n-octadecyl phosphonic acid was subjected to a test in which the aluminum alloy plate was stored in an environment at a temperature of 40° C. and a relative humidity of 90%. Electron microscope images of the surface of the aluminum alloy plate were obtained at the start of the test (initial stage) and at 1 week, 1 month, 2 months or 1 year after the start of the test. The images are shown in FIG. 1.

As shown in FIG. 1, while the fine irregularities disappeared over time at the aluminum alloy plate not treated with n-octadecyl phosphonic acid, the fine irregularities were observed at the aluminum alloy plate treated with n-octadecyl phosphonic acid even after a long period of time from the start of the test.

### (3) Resin Joining Test

The aluminum alloy plate treated with n-octadecyl phosphonic acid was disposed at a mold for insert molding and melted polypropylene (PP) was injected therein, thereby preparing five specimens in which PP was joined at a surface of the aluminum alloy plate having irregularities formed thereon. The shear joining strength of the specimens was measured with an autograph (AGS-500-D, TYPE-III, Shimadzu Corporation). The arithmetic average value of the measured values of the five specimens was 28 MPa.

For the purpose of comparison, specimens were prepared from the aluminum alloy plate not treated with n-octadecyl phosphonic acid in the same manner, and the shear joining strength was measured. The result was 29 MPa.

In view of the foregoing, it was found that the treatment with n-octadecyl phosphonic acid had less effect on the joining strength of the aluminum alloy (A3003) with respect to PP.

### Example 2

### (1) Surface Treatment of Aluminum Alloy Plate

A plate formed of aluminum alloy (A6063) was subjected to a roughening treatment and a treatment with n-octadecyl phosphonic acid in the same manner with Example 1. The contact angle with respect to ion exchange water at the surface of the aluminum alloy plate after the treatment was measured in the same manner with Example 1. The result was 120°.

### (2) High-Temperature High-Humidity Storage Test

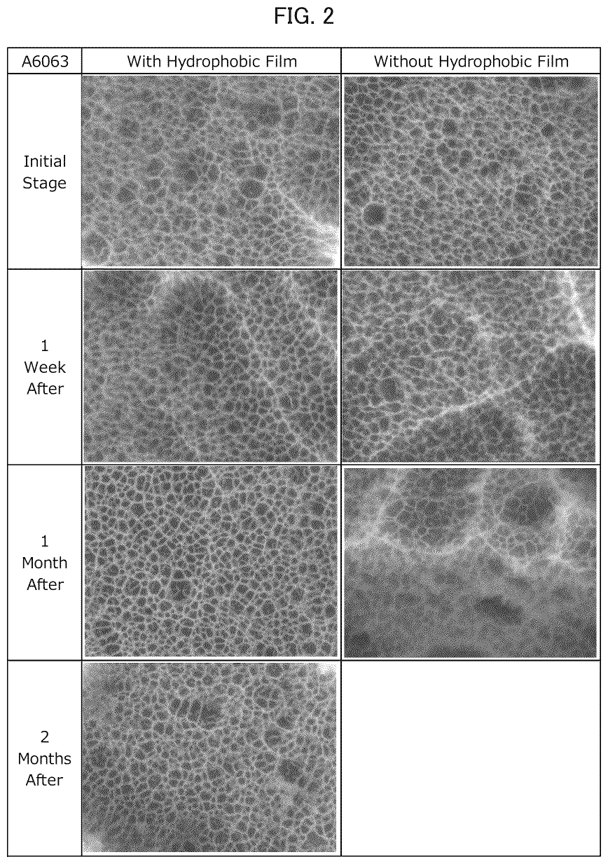

The aluminum alloy plate treated with n-octadecyl phosphonic acid was subjected to a test in which the aluminum alloy plate was stored in an environment at a temperature of 40° C. and a relative humidity of 90%. Electron microscope images of the surface of the aluminum alloy plate were obtained at the start of the test (initial stage) and at 1 week, 1 month or 2 months after the start of the test. The images are shown in FIG. 2.

For the purpose of comparison, an aluminum alloy plate not treated with n-octadecyl phosphonic acid was subjected to a test in which the aluminum alloy plate was stored in an environment at a temperature of 40° C. and a relative humidity of 90%. Electron microscope images of the surface of the aluminum alloy plate were obtained at the start of the test (initial stage) and at 1 week, 1 month or 2 months after the start of the test. The images are shown in FIG. 2.

As shown in FIG. 2, while the fine irregularities disappeared over time at the aluminum alloy plate not treated with n-octadecyl phosphonic acid, the fine irregularities were observed at the aluminum alloy plate treated with n-octadecyl phosphonic acid even after a long period of time from the start of the test.

### (3) Resin Joining Test

The aluminum alloy plate treated with n-octadecyl phosphonic acid was disposed at a mold for insert molding and melted polypropylene (PP) was injected therein, thereby preparing five specimens in which PP was joined at a surface of the aluminum alloy plate having irregularities formed thereon. The shear joining strength of the specimens was measured with an autograph (AGS-500-D, TYPE-III, Shimadzu Corporation). The arithmetic average value of the measured values of the five specimens was 29 MPa.

For the purpose of comparison, specimens were prepared from the aluminum alloy plate not treated with n-octadecyl phosphonic acid in the same manner, and the shear joining strength was measured. The result was 29 MPa.

In view of the foregoing, it was found that the treatment with n-octadecyl phosphonic acid had less effect on the joining strength of the aluminum alloy (A6063) with respect to PP.

Specimens were prepared in which PP was changed to polyphenylene sulfide (PPS) in the same manner, and the shear joining strength was measured. The result was 42 MPa.

For the purpose of comparison, specimens were prepared from the aluminum alloy plate not treated with n-octadecyl phosphonic acid in the same manner, and the shear joining strength was measured. The result was 43 MPa.

In view of the foregoing, it was found that the treatment with n-octadecyl phosphonic acid had less effect on the joining strength of the aluminum alloy (A6063) with respect to PPS.

### Example 3

### (1) Surface Treatment of Aluminum Alloy Plate

A plate formed of aluminum alloy (A6061) was subjected to a roughening treatment and a treatment with n-octadecyl phosphonic acid in the same manner with Example 1. The contact angle with respect to ion exchange water at the surface of the aluminum alloy plate after the treatment was measured in the same manner with Example 1. The result was 115°.

### (2) High-Temperature High-Humidity Storage Test

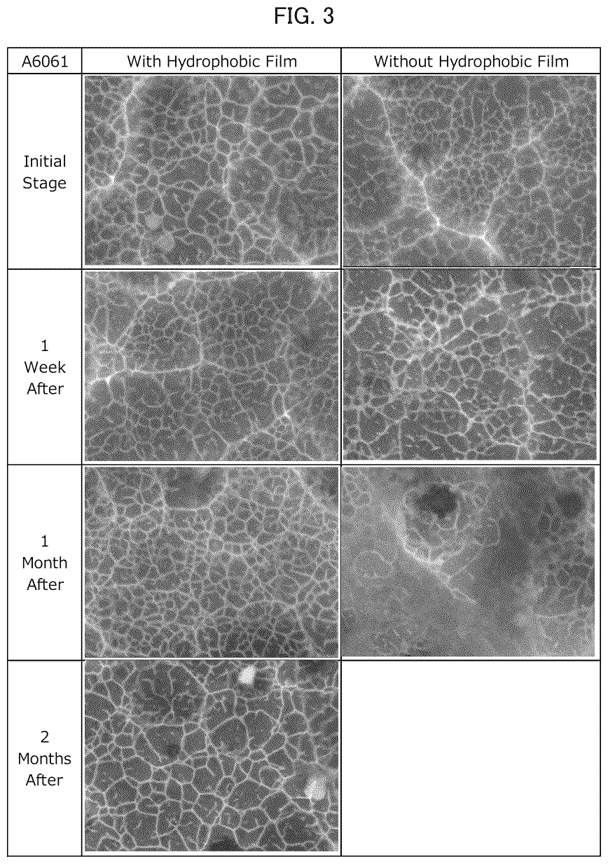

The aluminum alloy plate treated with n-octadecyl phosphonic acid was subjected to a test in which the aluminum alloy plate was stored in an environment at a temperature of 40° C. and a relative humidity of 90%. Electron microscope images of the surface of the aluminum alloy plate were obtained at the start of the test (initial stage) and at 1 week, 1 month or 2 months after the start of the test. The images are shown in FIG. 3.

For the purpose of comparison, an aluminum alloy plate not treated with n-octadecyl phosphonic acid was subjected to a test in which the aluminum alloy plate was stored in an environment at a temperature of 40° C. and a relative humidity of 90%. Electron microscope images of the surface of the aluminum alloy plate were obtained at the start of the test (initial stage) and at 1 week, 1 month or 2 months after the start of the test. The images are shown in FIG. 3.

As shown in FIG. 2, while the fine irregularities disappeared over time at the aluminum alloy plate not treated with n-octadecyl phosphonic acid, the fine irregularities were observed at the aluminum alloy plate treated with n-octadecyl phosphonic acid even after a long period of time from the start of the test.

### (3) Resin Joining Test

The aluminum alloy plate treated with n-octadecyl phosphonic acid was disposed at a mold for insert molding and melted polypropylene (PP) was injected therein, thereby preparing five specimens in which PP was joined at a surface of the aluminum alloy plate having irregularities formed thereon. The shear joining strength of the specimens was measured with an autograph (AGS-500-D, TYPE-III, Shimadzu Corporation). The arithmetic average value of the measured values of the five specimens was 26 MPa.

For the purpose of comparison, specimens were prepared from the aluminum alloy plate not treated with n-octadecyl phosphonic acid in the same manner, and the shear joining strength was measured. The result was 28 MPa.

In view of the foregoing, it was found that the treatment with n-octadecyl phosphonic acid had less effect on the joining strength of the aluminum alloy (A6061) with respect to PP.

### Example 4

### (1) Surface Treatment of Aluminum Alloy Plate

A plate formed of aluminum alloy (A3003) was subjected to a roughening treatment in the same manner with Example 1. The aluminum alloy plate was dipped in an ethanol solution containing each of the following hydrophobizing agents 1 to 5 (5 mmol/L) for 1 minute. Thereafter, the aluminum alloy plate was washed with ethanol and dried at 80° C. for 20 minutes, and the contact angle with respect to ion exchange water was measured in the same manner with Example 1. The results are shown in Table 1.
Organic Compound 1: propyl phosphonic acid
Organic Compound 2: undecyl phosphonic acid
Organic Compound 3: 10-carboxydecyl phosphonic acid
Organic Compound 4: 11-hydroxyundecyl phosphonic acid
Organic Compound 5: 11-aminoundecyl phosphonic acid

### (2) High-Temperature High-Humidity Storage Test

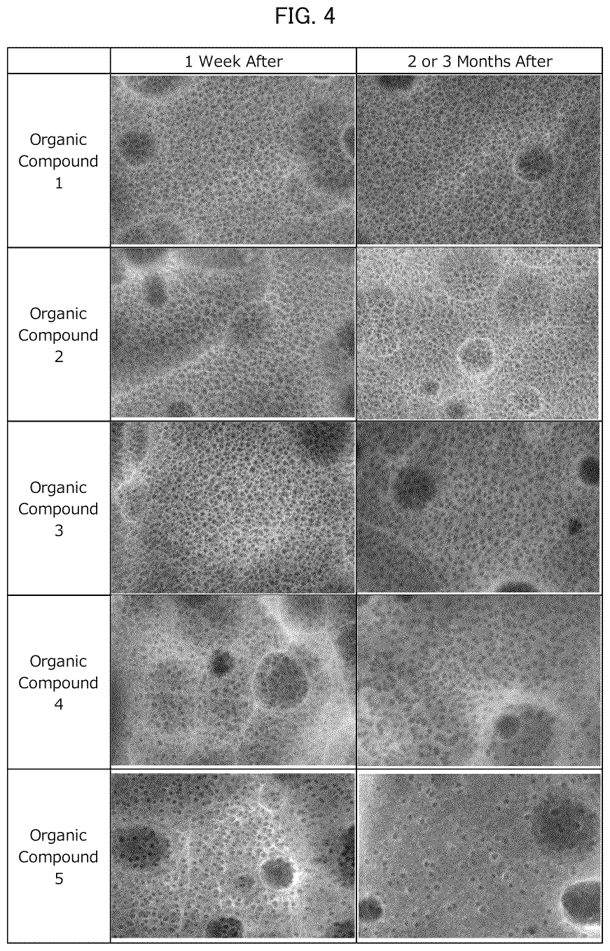

The aluminum alloy plate treated with each of the organic compounds 1-5 was subjected to a test in which the aluminum alloy plate was stored in an environment at a temperature of 40° C. and a relative humidity of 90%. Electron microscope images of the surface of the aluminum alloy plate were obtained at 1 week, 2 months or 3 months after the start of the test. The images are shown in FIG. 4.

As shown in FIG. 4, the fine irregularities were observed at the aluminum alloy plate treated with each of the organic compounds 1-5 even after a long period of time from the start of the test.

### (3) Resin Joining Test

The aluminum alloy plate treated with each of the organic compounds 1-5 was disposed at a mold for insert molding and melted polyphthalamide (PPA) was injected therein, thereby preparing five specimens in which PPA was joined at a surface of the aluminum alloy plate having irregularities formed thereon. The shear joining strength of the specimens was measured with an autograph (AGS-500-D, TYPE-III, Shimadzu Corporation). The arithmetic average values of the measured values of the five specimens are shown in Table 1.

For the purpose of comparison, specimens were prepared from the aluminum alloy plate not treated with the organic compound in the same manner, and the shear joining strength was measured. The results are shown in Table 1.

TABLE 1

| Organic | Contact Angle | Shear Joining Strength |
|---|---|---|
| Compound | [°] | [MPa] |
| none | 0 | 22.3 |
| 1 | 138 | 19.1 |
| 2 | 147 | 16.7 |
| 3 | 146 | 20.4 |
| 4 | 126 | 22.7 |
| 5 | 0 | 22.2 |

In view of the results shown in Table 1, it was found that the treatment with the organic compounds 1-5 had less effect on the joining strength of the aluminum alloy plate with respect to PPA.

It was found that the effect on the joining strength of the aluminum alloy plate with respect to PPA was smaller in the cases of using the organic compound 1 having an alkyl group with a carbon number of 3, and the organic compounds 3-5 having a polar group, as compared with the case of using the organic compound 2 having an alkyl group with a carbon number of 11 and not having a polar group.

The disclosure of Japanese Patent Application No. 2022-025116 is incorporated herein by reference in its entirety.

All publications, patent applications, and technical standards mentioned in the present specification are incorporated herein by reference to the same extent as if each individual publication, patent application, or technical standard was specifically and individually indicated to be incorporated by reference.

1. A metal member, comprising a surface having irregularities, the surface being covered with a hydrophobic film.

2. A metal member, comprising a surface having irregularities, the surface having a contact angle with respect to water of 90° or more.

3. A metal member, comprising a surface having irregularities, the surface having an organic compound that is chemically bonded to the surface.

4. The metal member according to claim 3, wherein the organic compound has a polar group.

5. The metal member according to claim 1, wherein the irregularities comprise a dendritic morphology.

6. The metal member according to claim 5, wherein the dendritic morphology has an average thickness of from 20 nm to 1000 nm.

7. The metal member according to claim 1, wherein the surface has an average value of ten-point average roughness (Rzjis) of from 2 μm to 50 μm.

8. The metal member according to claim 1, wherein the surface has an average value of average length of roughness curve element (RSm) of from 10 μm to 400 μm.

9. The metal member according to claim 1, comprising aluminum.

10. A metal-resin composite body, comprising the metal member according to claim 1, and a resin member that is joined to the surface having the irregularities of the metal member.

11. A method for producing a metal member, the method comprising:
forming irregularities at a surface of a metal member; and
applying an organic compound to the surface at which the irregularities have been formed.

12. The method for producing a metal member according to claim 11, wherein the organic compound has an alkyl group with a carbon number of from 1 to 20.

13. The method for producing a metal member according to claim 11, wherein the organic compound has a polar group.
